(19) United States
(12) Patent Application Publication
(10) Pub. No.: US 2005/0149921 A1
(43) Pub. Date: Jul. 7, 2005

(54) Software module update

(76) Inventor: Douglas L. Rollins, Nampa, ID (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/984,184

(22) Filed: Nov. 9, 2004

Related U.S. Application Data
(63) Continuation of application No. 09/272,845, filed on Mar. 19, 1999, now abandoned.

(51) Int. Cl. G06F 9/44

(52) U.S. Cl. 717/168; 719/327

(57) ABSTRACT

A technique to update a software module includes identifying a first version of the software module, identifying a second version of the software module, determining which of the first and second versions of the software module is the most current version, and indicating that version of the software module determined to be most current. Techniques in accordance with the invention may also include obtaining that version of the software module determined to be the most current version and, possibly, loading the obtained version of the software module onto a user's computer system. Methods in accordance with the invention may be stored in any media that is readable and executable by a programmable control device.

### BACKGROUND

The invention relates generally to computer system operations and, more particularly, to software module update techniques.

Over time, program modules such as driver routines, program applications and program documentation may become outdated. While the problem of obsolescence exists for many products, it is a particular problem for personal computer (PC) users. The speed with which changes can occur in the field of PCs can make program modules loaded today, outdated tomorrow.

Many software and hardware vendors provide software update facilities for users of their products. Typically, updates are available via world wide web sites and/or dial-in servers. Such services, while capable of providing a user with the needed software or documentation, may require the user have detailed technical knowledge about the product being updated. To properly obtain a driver update for a small computer systems interface (SCSI) controller card, for example, the user may need to know (among other things) the SCSI card version number and the SCSI card's basic input-output system (BIOS) version number. This level of technical information, or the expertise to obtain it, is above many user's capability. In addition, the user must be able to physically transfer (pull) the desired update module from that location at which they found it to their personal computer system. Further, this operation must be repeated for each device and/or software application that they want to update.

Thus, it would be beneficial to provide improved techniques by which users may obtain relevant updates to their existing software modules.

### SUMMARY

In one embodiment, the invention provides a method to update a software module. The method includes identifying a first version of the software module, identifying a second version of the software module, determining which of the first and second versions of the software module is the most current version, and indicating that version of the software module determined to be most current. Methods in accordance with the invention may also include obtaining that version of the software module determined to be the most current version and, possibly, loading the obtained version of the software module onto a user's computer system. Methods in accordance with the invention may be stored in any media that is readable and executable by a programmable control device.

### BRIEF DESCRIPTION OF THE DRAWINGS

FIG. 1 shows a system that provides software module update capability is shown in accordance with one embodiment of the invention.

FIG. 2 shows the flowchart of a method to provide software module update capability in accordance with one embodiment of the invention.

### DETAILED DESCRIPTION

Techniques (including methods and devices) to enable software module updates are described. The following embodiments, described in terms of techniques to update program applications and software driver modules, are illustrative only and are not to be considered limiting in any respect. Further, in the interest of clarity not all features of an actual implementation are described herein. It will be appreciated that the development of any actual implementation requires numerous programming decisions to achieve the developer's specific goals such as compliance with system-related and business-related constraints. Moreover, these decisions may be complex and time-consuming but would nevertheless be a routine undertaking for those of ordinary skill having the benefit of this disclosure.

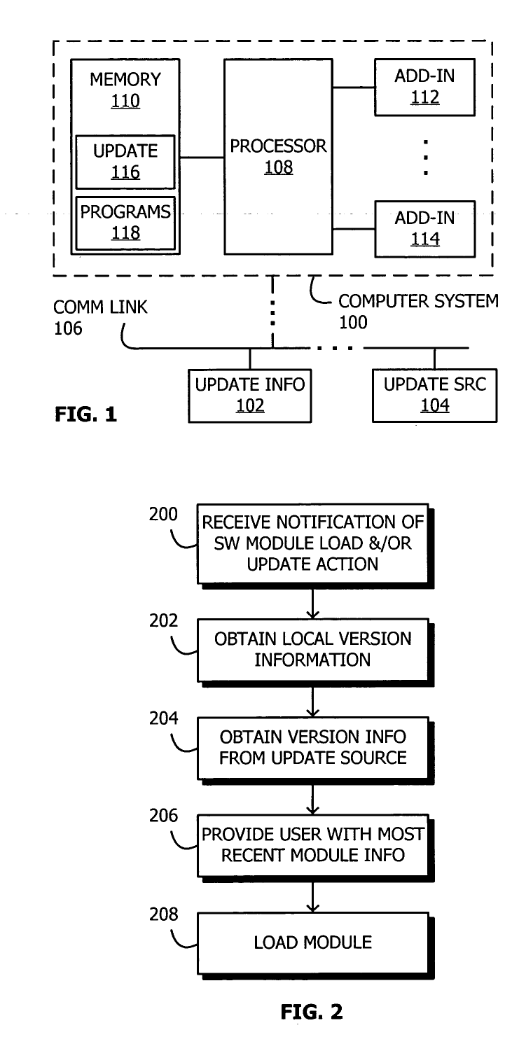

Referring to FIG. 1, a system that provides software module update capability is shown in accordance with one embodiment of the invention. Computer system 100 may be coupled to update information 102 and update source 104 via communication link 106. Illustrative computer systems include general purpose (e.g., PCs) and special purpose (e.g., graphics workstations) computer systems. Update information 102 may be a database or other information storage facility that includes versioning information for various software modules. Update source 104 represents that location or locations at which software module updates are stored. Communication link 106 may be a modem connection, or a direct connection to a local area or wide area network. The form of communication link 106 is irrelevant to the invention and may, for example, employ copper wire, radio frequency or optical technologies. It will be understood that update information 102 and update source 104 may be co-located. It will be further understood that update source 104 may include multiple sites (e.g., various world wide web sites).

Update information 102 may include a variety of data for each software module that may be updated in accordance with the invention. For example, update information 102 may be organized as a database with one record for each available software module. (Software modules may include user programs such as word processing and graphics applications, or drivers to control either a hardware device (device driver) or another software subsystem.) Each record may include information representing one or more of the following: software module name; manufacturer's identification number, device identification number; device version number; BIOS version number; driver version number; date; an indication of what versions the current version is an update for; and a location of the identified module.

Referring again to FIG. 1, computer system 100 may include processor 108, memory 110, and possibly add-in cards such as video and modem cards 112 and 114 respectively. Illustrative processors include the PENTIUM® family of processors and the 80×86 families of processors from Intel Corporation. Memory 110 may include volatile (e.g., dynamic random access memory) and/or non-volatile memory (e.g., non-volatile random access memory, magnetic or optical disk units). Add-in cards represent physical devices that augment the processing features of processor 108. Typically, an add-in card includes a programmable control device (e.g., a microprocessor, microcontroller, or a specially designed programmable state machine) and associated control memory (often referred to as BIOS).

As shown, memory 110 may include update routine 116 and one or more software programs 118. Update routine 116 represents one or more software program modules that works in conjunction with update information 102 and update source 104 to provide the software module update capability of the present invention. Programs 118 represents one or more user or operating system applications which may be updated by update routine 116.

Referring to FIG. 2, a method to provide software module update capability is shown in accordance with one embodiment of the invention. Initially a user indicates they want to load a new program module or update an existing module (block 200). For example, a user may have purchased a new video controller add-in card and now wants to install the appropriate device drivers. Update routine 116 may receive this notification in any convenient manner.

Following notification, update routine 116 obtains version information for the module being loaded/updated (block 202). If the module being updated is associated with a software application, version information may be obtained through standard queries to, or inspection of, one or more of computer system 100's system files. If the module being updated is associated with a hardware device (e.g., an add-in card), update routine 116 may interrogate the card directly to obtain one or more of the following: a device identifier value; a subsystem identifier value; a device version identifier value; the device's BIOS version identifier value; and the version number of any currently loaded device drives associated with the device.

Identification of version information for a software application or a previously loaded device driver may be obtained through standard queries to, or inspection of, one or more of computer system 100's system files. By way of example, in a Microsoft Windows® operating system information about those driver routines and program applications that are loaded may be obtained from the Registry file. Direct interrogation of a physical device (e.g., video controller or network interface cards) to determine the device's version information is preferred over an inspection of system files such as the Windows® Registry file.

Following the acts of block 202, update routine 116 may communicate with update information 102 via communication link 106 to determine what program modules are the most current for the identified device or program (block 204). Next, update routine 116 indicates the most recent module (e.g., device driver or program) to the user (block 206) which may then be loaded from update source 104 in accordance with current techniques (block 208). The acts of FIG. 2 may be initiated when a user begins installation of a new device or program or at any subsequent time specified by the user.

In one embodiment, update routine 116 shows only the most current modules for loading to the user by comparing the version obtained via interrogating system 100 (the acts of block 202) and the information obtained from update information 102 (the acts of block 204). It will be recognized that the update module (i.e., that module which will update the module identified during the acts of blocks 100 and 102) may be obtained from any location (update source 104) in communication with computer system 100. For example, a video controller add-in card's device driver may be located at the video card's manufacturer's website or at the website of an original equipment manufacturer who assembled and sold the video card with computer system 100. The update module may also be local to computer system 100.

One benefit of the invention is that it allows a user to maintain their system in an up to date state without requiring them to have or obtain detailed technical information about system components. Another benefit of the invention is that update routine 116 may also prevent use of inappropriate updates. For example, if a user's network controller card is not capable of using the chronologically most recent update, but instead may only use those driver versions before a specified date, update routine 116 may obtain this information from update information 102 and display only the most “relevant” current version to the user for loading during the acts of block 206 and 208. Yet another benefit of the invention is that a user does not have to know where a needed update module is located. In one embodiment the user only needs to know where or how to establish communication with update information 102. In another embodiment, the location of update information 102 may be predetermined by the computer system vendor. Still another benefit of the invention is the automatic nature of update routine 116. That is, update routine 116 determines not only what driver updates are appropriate but may also (automatically or following user authorization) retrieve the update modules/software and install them on a user's machine. Thus, in contrast to prior art update techniques the user does not have to know: the technical details of their system's current software load (e.g., drivers and application programs); explicit location(s) where various update modules may be located; or how to affirmatively download the various update routines.

Various changes in the materials, components, circuit elements, as well as in the details of the illustrated operational method are possible without departing from the scope of the claims. For instance, acts in accordance with FIG. 2 may be performed by a programmable control device executing instructions organized into a program module (e.g., update routine 116). A programmable control device may be a single computer processor (e.g., processor 108), a plurality of computer processors coupled by a communications link, or a custom designed state machine. Custom designed state machines may be embodied in a hardware device such as a printed circuit board comprising discrete logic, integrated circuits, specially designed application specific integrated circuits (ASICs), or field programmable gate array devices. Storage devices suitable for tangibly embodying program instructions include all forms of non-volatile memory including, but not limited to: semiconductor memory devices such as EPROM, EEPROM, and flash devices; magnetic disks (fixed, floppy, and removable); other magnetic media such as tape; and optical media such as CD-ROM disks.

While the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

1-49. (canceled)

50. A method to update a device driver comprising:
receiving an add-in card having at least one device driver; and
reading data comprising at least one of a device identifier value, a subsystem identifier value, a device version identifier value, a device BIOS identifier value, and a version number of a currently loaded device driver from the add-in card;
determining a first version of a device driver from the data;
identifying a second version of a device driver;
determining which of the first version and the second version is a current version; and
automatically installing the current version of the device driver on the add-in card.

51. The method of claim 50 wherein automatically installing further comprises automatically installing the second version of the device driver in the add-in card when the second version is the current version.

52. The method of claim 50 further comprising indicating the version of the device driver determined to be most current.

53. The method of claim 50 further comprising indicating by a user to update the device driver of the add-in card.

54. The method of claim 50 wherein the second version of the device driver is located at a website of a manufacturer of the add-in card.

55. The method of claim 50 wherein a computer system comprises the add-in card and wherein the second version of the device driver is located at a website of an original equipment manufacturer who assembled and sold the add-in card with the computer system.

56. The method of claim 50 wherein a computer system comprises the add-in card and wherein the second version of the device driver is stored in memory associated with the computer system.

57. The method of claim 50 further comprising, when the add-in card is not capable of using the device driver after a specified version date:
determining if the current version of the device driver has a version date before the specified version date; and
installing the current version of the device driver on the add-in card when the version date is before the specified version date.

58. An apparatus for updating a device driver comprising:
an add-in card having at least one device driver;
an update routine to read data comprising at least one of a device identifier value, a subsystem identifier value, a device version identifier value, a device BIOS identifier value, and a version number of a currently loaded device driver from the add-in card, and to determine a first version of the device driver from the data;
update information to identify a second version of the device driver, and to determine which of the first version and the second version is the current version; and
an update source to provide the current version of the device driver for automatic installation on the add-in card.

59. The apparatus of claim 58 wherein the update information indicates the version of the device driver determined to be most current.

60. The apparatus of claim 58 wherein the update routine receives an indication by a user to update the device driver of the add-in card.

61. The apparatus of claim 58 wherein the second version of the device driver is located at a website of a manufacturer of the add-in card.

62. The apparatus of claim 58 wherein a computer system comprises the add-in card and wherein the second version of the device driver is located at a website of an original equipment manufacturer who assembled and sold the add-in card with the computer system.

63. The apparatus of claim 58 wherein a computer system comprises the add-in card and wherein the second version of the device driver is stored in memory associated with the computer system.

64. The apparatus of claim 58 wherein the update routine, when the add-in card is not capable of using the device driver after a specified version date, determines if the current version of the device driver has a version date before the specified version date, and installs the current version of the device driver on the add-in card when the version date is before the specified version date.

65. An article of manufacture comprising computer useable medium having computer readable program code embodied therein, the computer readable program code comprising:
computer readable program code configured to read device driver data comprising at least one of a device identifier value, a subsystem identifier value, a device version identifier value, a device BIOS identifier value, and a version number of a currently loaded device driver from an add-in card;
computer readable program code configured to determine a first version of the device driver from the data;
computer readable program code configured to identify a second version of the device driver;
computer readable program code configured to determine which of the first version and the second version is a current version; and
computer readable program code configured to automatically install the current version of the device driver on the add-in card.

66. The article of manufacture of claim 65 further comprising computer readable program code configured to indicate the version of the device driver determined to be most current.

67. The article of manufacture of claim 65 further comprising computer readable program code configured to receive an indication by a user to update the device driver of the add-in card.

68. The article of manufacture of claim 65 wherein the second version of the device driver is located at a website of a manufacturer of the add-in card.

69. The article of manufacture of claim 65 wherein a computer system comprises the add-in card and wherein the second version of the device driver is located at a website of an original equipment manufacturer who assembled and sold the add-in card with the computer system.

70. The article of manufacture of claim 65 wherein a computer system comprises the add-in card and wherein the second version of the device driver is stored in memory associated with the computer system.

71. The article of manufacture of claim 65 further comprising:
computer readable program code configured to determine, when the add-in card is not capable of using the device driver after a specified version date, if the current version of the device driver has a version date before the specified version date; and
computer readable program code configured to install the current version of the device driver on the add-in card when the version date is before the specified version date.

72. An apparatus for updating a device driver comprising:
means for receiving an add-in card having at least one device driver;
means for reading data comprising at least one of a device identifier value, a subsystem identifier value, a device version identifier value, a device BIOS identifier value, and a version number of a currently loaded device driver from the add-in card;
means for determining a first version of a device driver from the data;
means for identifying a second version of a device driver;
means for determining which of the first version and the second version is a current version; and
means for automatically installing the current version of the device driver on the add-in card.

73. The apparatus of claim 72 further comprising means for indicating the version of the device driver determined to be most current.

74. The apparatus of claim 72 further comprising means for receiving an indication by a user to update the device driver of the add-in card.

75. The apparatus of claim 72 wherein the second version of the device driver is located at a website of a manufacturer of the add-in card.

76. The apparatus of claim 72 wherein a computer system comprises the add-in card and wherein the second version of the device driver is located at a website of an original equipment manufacturer who assembled and sold the add-in card with the computer system.

77. The apparatus of claim 72 wherein a computer system comprises the add-in card and wherein the second version of the device driver is stored in memory associated with the computer system.

78. The apparatus of claim 72 when the add-in card is not capable of using the device driver after a specified version date, further comprising:
means for determining if the current version of the device driver has a version date before the specified version date; and
means for installing the current version of the device driver on the add-in card when the version date is before the specified version date.
